(19) United States
(12) Patent Application Publication
(10) Pub. No.: US 2009/0214826 A1
(43) Pub. Date: Aug. 27, 2009

(54) Controlling diamond film surfaces

(76) Inventors: Charles West, Chicago, IL (US); John Carlisle, Plainfield, IL (US); James Netzel, Yorkuille, IL (US); Neil Kane, Naperville, IL (US)

Correspondence Address: Olson & Cepuritis, LTD., 20 NORTH WACKER DRIVE, 36TH FLOOR, CHICAGO, IL, 60606, US

(21) Appl. No.: 12/319,229

(22) Filed: Jan. 2, 2009

Related U.S. Application Data
(60) Provisional application No. 61/019,165, filed on Jan. 4, 2008.

(51) Int. Cl. B32B 3/00; B24B 1/00

(52) U.S. Cl. 428/141; 451/36

(57) ABSTRACT

A method of preparing a low friction diamond surface comprises removing asperities from a surface of a polycrystalline diamond film disposed on a substrate, e.g., by removing not more than about 500 nm (e.g., not more than about 100 nm, 50 nm, 25 nm, or 10 nm) of diamond, on average, from the surface of the film. The removal step can be controlled to preserve depressions in the surface, which can provide useful properties, such as reservoirs for lubrication, which contribute to the low friction properties of diamond films prepared by the methods of the present invention. The diamond films of the invention preferably have an average grain size of about 2000 nm or less (e.g., less than or equal to about 1000 nm, 100 nm, 50 nm, 20 nm or 10 nm), and preferably include fewer than about 2000 asperities per square millimeter of diamond surface, or about 4/mm on a linear basis, as determined using a 2 μm diameter profilometer stylus tip.

### CROSS-REFERENCE TO RELATED APPLICATIONS

This application claims the benefit of U.S. Provisional Application Ser. No. 61/019,165, filed on January 4, 2008, which is incorporated herein by reference in its entirety.

### STATEMENT OF GOVERNMENT INTEREST

The United States Government has rights in this invention pursuant to Contract No. W-31-109-ENG-38 between the United States Government and The University of Chicago and/or pursuant to Contract No. DE-AC02-06CH11357 between the United States Government and UChicago Argonne, LLC representing Argonne National Laboratory.

### FIELD OF THE INVENTION

This invention relates to diamond films having relatively low friction surfaces and methods of preparing such diamond films.

### BACKGROUND

Diamond is a vital natural carbon material and one of the three more common natural carbon allotropes in addition to amorphous carbon and graphite. Diamond has many excellent properties including, for example, mechanical hardness, low wear rates, chemical inertness, and thermal conductivity. Diamond also can be made synthetically by man. One way to make synthetic diamond is by chemical vapor deposition (CVD). In this process, gases containing carbon are converted to diamond and take the form of either particulates or films (coatings), typically on a solid substrate. The resulting diamond films are further typically classified by their crystalline structure. The first and dominate structural classification results from the film being either single-crystalline or polycrystalline. Polycrystalline diamond films are typically further classified by the resulting grain size, orientation, and grain boundaries features. Examples of the common classification of polycrystalline-films include microcrystalline diamond, nanocrystalline diamond (NCD), and ultrananocrystalline diamond (UNCD). In addition, diamond films may comprise some non-diamond carbon portions, and the percentage of the non-diamond portion can be varied. Still further, non-carbon atoms can be introduced to vary the properties of the film. The specifics of the form, structure, and resulting properties of diamond can be dependent on the processing path and conditions. Hence, diamond is actually a family of materials, and these differences in the diamond structure can have important bearing on the applications and uses of such diamond materials. See for example U.S. Pat. No. 5,989,511 (Argonne National Laboratory).

In some applications, the surface properties of diamond are important. For example, friction, wear, and other tribological properties can depend highly on surface metrology. In many cases, diamond having controlled surface properties is needed. Diamond can be synthesized to have a smooth surface as made. Alternatively, diamond surfaces can be made smoother by polishing (see e.g., U.S. Pat. No. 5,702,586, which describes one process for polishing diamond. However, diamond is nature's hardest material, and polishing processes that smooth a diamond surface often are economically costly and inefficient. Hence, a need exists to develop better, more controlled diamond surfaces and processes for making same. In particular, better tribological properties and lower sliding friction are needed. In many cases, a need also exists to understand more fully how diamond surface metrology affects various applications and uses for diamond films.

### BRIEF SUMMARY OF THE INVENTION

Various embodiments of the present invention described herein include compositions, methods of making, methods of using, and devices.

In one aspect, the present invention provides a method for planarizing a diamond surface, e.g., to produce a low friction surface. The method comprises providing diamond film, preferably having an average grain size of about 2000 nm or less (e.g., comprising microcrystalline, nanocrystalline, or ultrananocrystalline diamond), disposed on a substrate, wherein the surface of the diamond film comprises diamond asperities and has a first or initial average diamond film thickness, and removing asperities from the surface to form a planarized diamond film. Optionally, the average film thickness is reduced from its initial state to a second or final average film thickness, which is not more than about 500 nm, preferably not more than about 100 nm (e.g., not more than 50, 25, or 10 nm) thinner, on average, than the initial diamond film thickness. In one embodiment, the final average film thickness and the initial average film thickness are about equal (i.e., essentially only the asperities are removed from the surface).

Preferably, the planarized diamond film has an average surface roughness (Rₐ) of about 50 nm or less (e.g., about 20 nm or less). In addition, the planarized diamond film preferably has an average grain size of about 100 nm or less, preferably about 20 nm or less (e.g., about 10 nm or less, or about 2 nm to about 10 nm). In some preferred embodiments, the planarized diamond film has a coefficient of sliding friction with SiC of less than about 0.10.

Typically, the planarized diamond film has fewer asperities per square millimeter than the initial surface of the diamond film (e.g., less than about 2000 asperities per mm²), wherein the asperities have a height/width ratio of greater than about 1:1 and a height above the average height of surface of the film of greater than about three times the average surface roughness (e.g., greater than about ten times the average surface roughness). The typical nanocrystalline or ultrananocrystalline film has an initial asperity surface density (before asperity removal) of at least about 4000 asperities/mm² (e.g., about 4000 to about 20000 asperities/mm²). Although asperity densities can be determined in a number of ways, asperity density values in units of “per square millimeter” (/mm²), as set forth herein and in the appended claims, are calculated values determined from a linear profilometry asperity density value (in asperities/mm) obtained with a profilometer stylus having a given tip diameter (in mm), by multiplying the linear value by the number of tip diameters per millimeter (i.e., multiplying the number of asperities/mm by 500/mm, for a profilometer tip diameter of 2 μm or 2×10⁻³ mm). Asperity density values provided on a linear “per millimeter” (/mm) basis, as set forth herein and in the appended claims, refer to values obtained by profilometry using a profilometer stylus having a tip diameter of 2 μm.

Generally, microcrystalline, nanocrystalline, and ultrananocrystalline diamond films include depressions in the surface thereof, e.g., about 1% to about 30% of the surface area of the film is depressed by more than about 25 nm compared to the average height of the surface. Preferably, these surface depressions are substantially preserved during the asperity removal process, so that the final planarized surface also comprises about 1 to about 30% of depressions having a depth of at least about 25 nm below the average height of the surface (i.e., the average distance from the substrate to the outer surface of the film, which is also equivalent to the average thickness of the film).

In the methods of the present invention, the diamond asperities can be removed by a variety of methods as described elsewhere herein, including exposure to oxygen-containing plasma (e.g., for about 60 minutes or less). In such cases, the removal step preferably is carried out in the same instrument as the instrument used to deposit or form the diamond film on the substrate.

In another embodiment, the removal step comprises polishing the film surface with an abrasive material for a time sufficient to remove asperities from the surface, preferably to reduce the number of asperities on the surface to 2000 or fewer per square millimeter (e.g., by polishing with an abrasive for about 10 minutes or less). The abrasive preferably comprises slurry of abrasive particles (e.g., diamond, silicon carbide, zirconia, or alumina particles). Because only a relatively thin layer of diamond needs to be removed from the film surface in the methods of the present invention, the polishing can be performed on a standard polishing apparatus using a slurry of abrasive particles, and a downforce of about 3 pounds-per-square inch (psi) or less.

In another embodiment, the removal step comprises subjecting the film to laser ablation, preferably at a laser irradiance sufficient to remove asperities from the surface, e.g., laser ablation with a laser irradiance level impinging on the film surface of less than about 5.0×10⁵ W/cm².

Alternatively, the removal step can comprise isotropic etching (e.g., using a plasma) or wet chemical etching.

In another aspect, the present invention provides articles of manufacture comprising a diamond film prepared by any of the methods described herein. A preferred article of manufacture comprises a substrate having a polycrystalline diamond film (preferably having an average grain size of about 2000 nm or less (e.g., microcrystalline, nanocrystalline or ultrananocrystalline diamond having a grain size of about 1000 nm or less, 100 nm or less, 50 nm or less, 20 nm or less or 10 nm or less) disposed on a surface of the substrate. The film preferably includes surface depressions at a density of about 1% to about 30% by area. Preferably, the depressions are about 25 nm or greater deep compared to the average height of the surface. Preferably, the film has an average surface roughness, Rₐ, of about 50 nm or less (e.g., about 20 nm or less) and has a sliding coefficient of friction with SiC of less than about 0.1. In one embodiment, the diamond film has fewer than about 2000 asperities per square millimeter (mm 2), wherein the asperities have a height/width ratio of greater than about 1:1 and a height above the average height of surface of the film of greater than about three times (e.g., greater than 8 times) the average surface roughness.

The following are examples illustrating characteristics of some preferred embodiments of the articles and methods of the present invention:

A. The planarized diamond film has an average surface roughness of about 20 nm or less and an average grain size of about 1000 nm or less (e.g., less than or equal to about 100, 50, 20 or 10 nm), and the removal step is performed in about 60 minutes or less.

B. The planarized diamond film has an average surface roughness of about 20 nm or less and an average grain size of about 1000 nm or less (e.g., less than or equal to about 100, 50, 20 or 10 nm), and the removal step is performed in about 10 minutes or less.

C. The substrate comprises silicon carbide, the planarized diamond film has an average surface roughness of about 20 nm or less and an average grain size of about 1000 nm or less (e.g., less than or equal to about 100, 50, 20 or 10 nm), and the removal step is performed in about 60 minutes or less.

D. The substrate comprises silicon carbide, the planarized diamond film has an average surface roughness of about 20 nm or less and an average grain size of about 1000 nm or less (e.g., less than or equal to about 100, 50, 20 or 10 nm), and the removal step is performed in about 10 minutes or less.

E. The substrate comprises silicon carbide, the planarized diamond film has an average surface roughness of about 20 nm or less and an average grain size of about 1000 nm or less (e.g., less than or equal to about 100, 50, 20 or 10 nm), the removal step is performed in about 60 minutes or less, and the final average diamond film thickness is not more than about 25 nm thinner than the initial average diamond film thickness.

F. The substrate comprises silicon carbide, the planarized diamond film has an average surface roughness of about 20 nm or less and an average grain size of about 1000 nm or less (e.g., less than or equal to about 100, 50, 20 or 10 nm), the removal step is performed in about 10 minutes or less, and the final average diamond thickness not more than about 25 nm thinner than the initial average diamond film thickness.

G. The substrate comprises silicon carbide, the diamond comprises ultrananocrystalline diamond, the planarized diamond film has an average surface roughness of about 20 nm or less and an average grain size of about 1000 nm or less (e.g., less than or equal to about 100, 50, 20 or 10 nm), the removal step is performed in about 10 minutes or less, and the final average diamond film thickness is not more than about 25 nm thinner than the initial average diamond film thickness.

An advantage for at least one of the embodiments described herein includes, among others, a more economically efficient process for controlling diamond surface structure than those known in the prior art. The present inventors have discovered that a surprisingly low friction diamond surface can be prepared (e.g., a coefficient of sliding friction against SiC of 0.1 or less) can be achieved by removing not more than about 500 nm (e.g., not more than about 100 nm, 50 nm, 20 nm, or 10 nm), on average, of diamond from the surface of a diamond (e.g., nanocrystalline or ultrananocrystalline diamond) film. Because only a relatively small amount of expensive diamond material is removed, waste is minimized and the time required to prepare the low friction surface is vastly decreased compared to the prior art methods (e.g., planarization of the surface typically can be accomplished in less than an hour, compared to multiple hours using the prior art methods, thus saving valuable processing time. Another advantage for at least one of the embodiments described herein includes, among others, better performance including performance in tribological applications.

### BRIEF DESCRIPTION OF THE DRAWINGS

FIG. 1 is a representative 50×50 μm Atomic Force Microscopy (AFM) topographical map of an “as-deposited” UNCD film showing relatively narrow asperities of greater than 100 nm in height.

FIG. 2 is a scanning electron micrograph of a UNCD film planarized by methods described herein.

FIG. 3 shows AFM data illustrating in cross-sectional analysis particular depressions in the surface which remain after planarizing.

FIG. 4 shows AFM data illustrating in perspective view the surface after planarizing.

FIG. 5 shows AFM data illustrating from a top view the surface after planarizing including a histogram of the surface roughness.

FIG. 6 is a graph of the roughness of 9 seals, in their original form (SiC surface), after UNCD diamond deposition and after a 90 second diamond slurry polish

FIG. 7 is a graph of the asperity count (asperity defined as heights greater than 100 nm above the average height) of 6 seals, in their original as-received form (SiC surface), after UNCD diamond deposition and after a 90 second diamond slurry polish.

FIG. 8 depicts a graph illustrating results of CoF testing for UNCD and SiC.

FIG. 9 is a photograph showing wear on a SiC pump seal.

FIG. 10 is a radial trace showing wear on a SiC seal.

FIG. 11 is a photograph showing reduced wear for a diamond-coated SiC pump seal compared to the SiC pump seal shown in FIG. 9.

FIG. 12 is a radial trace showing reduced wear for a diamond-coated SiC pump seal compared to the radial trace for a SiC pump seal shown in FIG. 10.

### DETAILED DESCRIPTION OF PREFERRED EMBODIMENTS

In one aspect, the present invention provides a method of preparing a planarized diamond film. The method comprises removing diamond asperities from the surface of a polycrystalline diamond film having an average grain size of about 2000 nm or less (e.g., a microcrystalline, nanocrystalline or ultrananocrystalline diamond film) disposed on a substrate. The diamond film includes diamond asperities on the surface, and depressions in the surface. The surface can be characterized by, for example, an average surface height above the substrate, an initial average film thickness, and an initial average surface roughness. The diamond asperities have a height/width ratio of greater than about 1:1, and a height above the average surface height of the film of greater than about three times the initial average surface roughness of the film. The depressions in the surface extend more than about 25 nm below the average surface height of the film. Preferably, the film has a final average film thickness, after removing asperities, which is not more than 500 nm thinner than the initial average film thickness of the film. Preferably, the surface of the film includes fewer than 2000 asperities per square millimeter of film surface.

In a preferred method aspect, about 1% to about 30% of the surface area of the film is depressed by more than about 25 nm below the average surface height of the film. Preferably, the depressions remain in the surface after the asperities are removed.

In one embodiment, the present invention provides a method of preparing a planarized diamond film comprising removing a layer of diamond having a thickness of not more than about 500 nm, on average, from the surface of a polycrystalline diamond film disposed on a substrate. The diamond film has an average surface roughness after removing the layer of diamond, which is less than the average surface roughness of the film before removing the layer of diamond. Preferably, the average surface roughness after removing the layer of diamond is not more than about 50 nm (e.g., not more than about 20 nm or not more than about 10 nm). Preferably, any depressions present on the surface of the film are preserved during the removal step.

In another aspect, the present invention provides an article comprising a diamond film prepared by a method of the present invention, e.g., an article comprising a substrate having disposed thereon a polycrystalline diamond film having an average grain size of about 2000 nm or less (e.g., less than or equal to about 1000, 100, 50, 20 or 10 nm), about 1% to about 30% of the surface of the film being depressed by about 25 nm or more compared to the average height of the surface. The film has an average surface roughness of about 50 nm or less, and includes fewer than about 2000 asperities per square millimeter, wherein the asperities have a height/width ratio of greater than about 1:1 and a height above the average height of surface of the film of greater than about three times the average surface roughness of the film. Preferably, the diamond has an average grain size of about 2000 nm or less, and a coefficient of sliding friction with SiC of less than about 0.1.

References cited herein are hereby incorporated by reference in their entireties. The following references, and other references cited herein, can be used as needed in the practice of the various embodiments described herein, including the making of diamond (e.g., nanocrystalline and ultrananocrystalline diamond).
Diamond can be made by chemical vapor deposition (CVD) methods. See for example U.S. Pat. Nos. 4,434,188; 5,204,145; and 5,523,121.
Diamond synthesis and characterization are also described in for example Gruen et al. (Eds.), Synthesis, Properties and Applications of Ultrananocrystalline Diamond, 2005.
Gruen, “Nanocrystalline Diamond Films,” Ann. Rev. Mater. Sci., 29, 211 (1999).
May et al. “Reevaluation of the mechanism for ultrananocrystalline diamond deposition from Ar/CH₄/H₂ gas mixtures”, J. Applied Phys., 99, 104907 (2006);
May et al. “Experiment and modeling of the deposition of ultrananocrystalline diamond films using hot filament chemical vapor deposition and Ar/CH₄/H₂ gas mixtures: A generalized mechanism for ultrananocrystalline diamond growth.” J. Applied Phys., 100, 024301 (2006).
May et al. “Microcrystalline, nanocrystalline and ultrananocrystalline diamond chemical vapor deposition: Experiment and modeling of the factors controlling growth rate, nucleation and crystal size”, J. Applied Phys., 101, 053115 (2007);
Wang et al., “The fabrication of nanocrystalline diamond films Using hot filament CVD”, Diamond Relat. Mater., 13(1), 6-13 (2004);
Xiao et al., “Low Temperature Growth of Ultrananocrystalline Diamond”, J. Applied Phys., 96, 2232 (2004);
Carlisle et al., “Characterization of nanocrystalline diamond films by core-level photoabsorption”, Appl. Phys. Lett. 68, 1640 (1996);
Schwarz et al., “Dependence of the growth rate, quality, and morphology of diamond coatings on the pressure during the CVD-process in an industrial hot-filament plant”, Diamond Relat. Mater., 11, 589 (2002);
James Birrell et al., “Morphology and Electronic Structure of Nitrogen-doped Ultrananocrystalline Diamond”, Appl. Phys. Lett. 81, 2235 (2002);
Birrell et al., “Interpretation of the Raman Spectra of Ultrananocrystalline Diamond”, Diamond Relat. Mater. 14, 86 (2005); and
Carlisle et al., Chem. Phys. Lett., 430(4-6), 345-350.

The diamond can be made by methods known in the art. See for example U.S. Pat. Nos. 5,989,511; 6,592,839; 5,849,079; 5,772,760; 5,614,258; 5,462,776; 5,370,855; 5,328,676; 5,209,916, and U.S. Patent Publication Nos. 2005/0031785; 2005/0042161; 2006/0131588; 2006/0222850 (Carlisle et al.).

In particular, U.S. Patent Publication 2005/0042161 describes phase pure ultrananocrystalline diamond, and diamond compositions described herein can consist essentially of microcrystalline, ultrananocrystalline diamond or nanocrystalline diamond.

### Substrates.

The substrate material supporting a diamond film of the present invention, and the surface thereof, can be for example a hard material or ultrahard material, such as those used in bearings, load bearing surfaces, abrasives, and (mechanical) seals such as, for example, a ceramic or an engineering ceramic such as, for example, silicon carbide (SiC), silicon nitride, cubic boron nitride (CBN), tungsten carbide (WC), WC with various binders, other solid solutions of metals and ceramics, metals, or metal alloys including steels, metal-matrix composites, and ceramic metal composites. Hard substrates, including silicon carbide (SiC), are described in for example U.S. Pat. Nos. 5,834,094; 5,952,080; 6,002,100; and 6,046,430. SiC can be used in a variety of forms and structures including alpha, beta, liquid impregnated, whisker reinforced, and in composites including for example SiC/C (see for example U.S. Pat. No. 6,355,206). The substrate material can be a seal, such as a pump seal, and the face of the seal can be oriented as needed for diamond deposition.

Other substrates include for example silicon, silicon dioxide, tungsten, molybdenum, copper, platinum, carbides, nitrides, oxides and other materials onto which diamond can be deposited.

Before the diamond deposition, the substrate can be characterized by an asperity density such as, for example, about 500 to about 20000 per square mm, or about 1000 to 15000 per square mm, or about 2000 to about 10000 per square mm. These values can be measured directly using an atomic force microscope (AFM), scanning electron microscope (SEM), or an optical or stylus-based profilometer. If a linear profilometry is used, then the asperity count or per unit length can be extrapolated into an asperity per unit area (asperity density) by correcting for the contact (if stylus) or inspection (if optical) width being used. The asperities can be those protrusions that have a height greater than about 100 nm above the average height.

In addition, before diamond deposition, the substrate can be characterized by an average surface roughness (Rₐ) of about 1 nm to about 25 nm, or about 2 nm to about 20 nm, or about 2 nm to about 15 nm.

### Asperities.

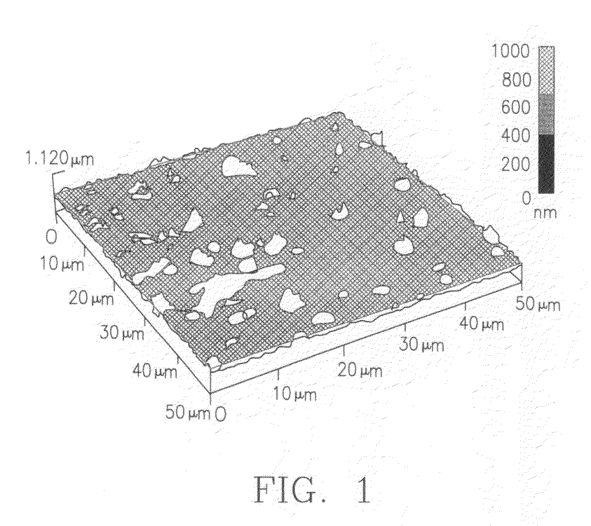

A particular aspect of surface roughness is the presence of asperities. Asperities can arise from a variety of sources including for example imperfections in the substrate or initial surface, non-uniform distribution or clumps of seed diamonds on the initial surface, and/or non-uniformities in processing conditions during diamond deposition. Asperities are protrusions from the surface of a diamond film or substrate, which have a height above the average surface of the film that is greater than the Rₐ of the surface, typically having a height that is greater than about three times the Rₐ of the surface. For example, the height of asperities above the average surface height of the film can be about 3 times to about 20 times, or about 5 times to about 20 times the Rₐ of the surface. Asperities can be slender in appearance and can have example height/width (H/W) aspect ratio of greater than 1:1. The H/W ratio can be for example about 2 to about 10. Examples of asperities are shown in the AFM image in FIG. 1.

### Removing Diamond Asperities.

The asperity removal steps can be carried out by methods known in the art, including for example contacting the surface with an abrasive material, such as a slurry of abrasive particles, with a polishing action, use of a plasma (e.g., an oxygen-containing plasma), isotropic etching (e.g., with a plasma or wet chemistry), ablation (e.g., laser ablation), and other methods. Etching processes are generally known as described in, for example, Madou, Fundamentals of Microfabrication, The Science of Miniaturization, 2^{nd} Ed. 2002.

Because only a relatively small amount of diamond material needs to be removed from the diamond film surface to remove asperities, the removal step can be carried out for relatively short periods of time such as, for example, about 60 minutes or less, or about 30 minutes or less, or about 2 minutes to about 10 minutes. One can adapt the removal time for a particular application, the cost-benefit of additional time, and need for commercial efficiency.

When polishing with abrasive material, a short polishing time can be used (e.g., about 60 minutes or less, or about 45 minutes or less, or about 30 minutes or less, or about 10 minutes or less, or about one minute to about 10 minutes). A relatively low down force (i.e., the force at which the abrasive material is contacted with the film surface) can be used such as, for example, about 3 psi or less or about 2 psi or less. A variety of abrasive surfaces can be used. For example, small, hard abrasive particles can be used. Examples of hard particles include diamond (e.g., nanodiamond), silicon carbide, alumina (e.g., alpha-alumina), zirconia, and other ceramic materials. A fixed abrasive film or pad can be used including those with small features. A slurry can be used both to transport abrasive particles uniformly across the film surface and also to remove debris, including asperity debris, from the surface once the asperities are removed from the underlying diamond film.

In another method of asperity removal, isotropic etching (e.g., using a plasma or wet chemistry) can be carried out. In one embodiment, an oxygen-containing plasma can be used. The removal step can comprise exposure to an oxygen-containing plasma for about 60 minutes or less. Oxygen-containing plasmas are generally known in the art including use with diamond. See for example U.S. Pat. Nos. 6,348,240 (Calvert) and 5,711,698 (Chakraborty) and 6,652,763 (Wei). Other isotropic etching methods include, for example, etching with a plasma containing both fluorine and oxygen atoms (e.g., SF₆/O₂).

In another method for asperity removal, ablation of the diamond surface, including laser ablation, can be carried out. See for example U.S. Pat. Nos. 4,987,007 (Wagal) and 5,747,120 (McClean). Laser pulses can be used with a pulse duration of for example about 10 ns to about 50 ns, or about 20 ns to about 50 ns, a total pulse energy of about 0.0002 J/pulse to about 0.1 J/pulse, and less than about 10¹⁰ W/cm² or less than about 10⁶ W/cm² or less than about 10⁵ W/cm² of irradiance on the surface of the material.

In some cases, the step of removing the diamond asperities can be carried out in the same instrument that was used for forming or depositing the diamond film. For example, equipment used in the semiconductor industry can be used or adapted, including multi-chamber instruments that have the same platform for the different chambers such as the same pump set.

In one embodiment, the removal step does not involve ion implantation, and does not involve electrochemical etching, as described in for example U.S. Pat. No. 5,702,586, and removal can be carried out without these steps.

### Diamond Parameters Before Asperity Removal.

The diamond film has a first or initial average film thickness measured before asperity removal. For example, this initial average thickness can be about 100 nm to about 10 microns, or about 500 nm to about 5 microns, or about one micron to about 3 microns. Average film thickness can be determined by, for example, ellipsometry.

The diamond film can be a polycrystalline diamond film, and can comprise polycrystalline diamond including microcrystalline diamond, nanocrystalline diamond or ultrananocrystalline diamond.

For example, the diamond film can be characterized by an average grain size of about 2000 nm or less, about 1000 nm or less, about 100 nm or less, about 50 nm or less, about 20 nm or less, or about 10 nm or less. A lower limit can be for example 1 nm or 2 nm or 3 nm. Average grain size can be measured by tunneling electron microscopy (TEM) analysis including HRTEM analysis, or alternatively by x-ray diffraction.

The diamond film can provide an asperity density of at least about 4000/mm² (e.g., about 4000/mm² to about 20000/mm²). On a linear basis, the film typically can have a linear asperity density of at least about 8/mm, e.g., about 8 to about 40/mm, prior to asperity removal, as determined by profilometry with a 2 micrometer diameter stylus tip. Asperity density can be measured by atomic force microscopy (AFM) and other profilometry analysis methods.

The asperities can have a height/width ratio of at least about 1:1, or at least about 2:1, or at least about 3:1. This ratio can be measured by AFM analysis.

The asperity can have a height per Rₐ of greater than about three (e.g., greater than about 10). This can be measured by AFM analysis.

The diamond surface can have an average surface roughness, Rₐ, of about 50 nm or less, or about 20 nm or less. This can be measured by AFM or profilometry.

The diamond surface preferably also comprises surface depressions, which can be measured by AFM and other profilometry analysis. The depression comprise a percentage of the surface area of about 1% to about 30% of the surface, or about 1% to about 20% of the surface, or about 2% to about 10% of the surface. The shape of the depressions can be, for example, a variety of random shapes. The shape can be non-conical. Typically, the depressions have a depth of at least about 25 nm below the average height of the surface.

After asperity removal, the diamond surface can be further treated to, for example, remove debris.

### Diamond Parameters After Asperity Removal.

After asperity removal, some diamond parameters will be substantially the same as before removal (for example, average grain size). Other parameters can be affected by the asperity removal (for example, the thickness or asperity density). The diamond film can, after asperity removal, be characterized by a second or final average film thickness. This second thickness can be similar to the first thickness. For example, the average film thickness may be reduced about 10% or less, or about 5% or less, or about 2% or less, or about 1% or less.

The difference between the initial average film thickness, before removal, and the final average film thickness, after removal, can be, for example, about 500 nm or less, or about 200 nm or less, or about 100 nm or less, or about 50 nm or less, or about 25 nm or less, or about 10 nm or less, or the initial and final film thicknesses can be about the same. The final thickness preferably is not more than about 100 nm thinner than the initial thickness. The average film thickness after asperity remove can be substantially the same as the initial average film thickness, since the amount of material removed from the surface during asperity removal may less than can be measured experimentally. Typically, asperity removal results in a measurable reduction in average diamond film thickness.

After asperity removal, the asperity density can be, for example, less than about 2000/mm², or less than about 500/mm², or less than about 300/mm². On a linear basis, the film preferably exhibits an asperity density of not more than about 4/mm after asperity removal, as determined by profilometry using a stylus having a tip diameter of 2 micrometers.

The Rₐ of the surface after asperity removal can be about 50 nm or less, or about 20 nm or less.

The average grain size after asperity removal can be about 20 nm or less, or about 10 nm or less.

The coefficient of sliding friction (SiC) after asperity removal can be less than about 0.1. This can be measured by methods known in the art. See for example U.S. Pat. No. 5,989,511.

After asperity removal, the planarized diamond film can have fewer than about 2000 asperities per mm², wherein the asperities have a height/width ratio of greater than about 1:1 and a height above the average height of the surface of the film greater than about three times the average surface roughness. Or, after removal, the planarized diamond film can have fewer than about 2000 asperities mm², wherein the asperities have a height/width ratio of greater than about 1:1 and a height above the average height of the surface of the film greater than about ten times the average surface roughness.

After removal, the planarized diamond film can have a surface comprising depressions wherein about 1% to about 30% of the surface, or about 15% to about 25%, or about 1% to about 20% of the surface, is depressed by more than about 25 nm compared to the average height of the surface. In some cases, these depressions are substantially similar to those present before the removal step. The depressions can provide useful properties, such as reservoirs for lubrication, which contribute to the low friction properties of diamond films prepared by the methods of the present invention.

### Applications.

Applications for the low friction diamond films of the present invention include for example tribological applications involving wear, friction, and lubrication performance including for example seals, mechanical seals, and pump seals.

### Working Examples

The following non-limiting examples set forth exemplary embodiments of the methods and articles of the present invention:

### Example 1

### Removal of Asperities to Planarize Ultrananocrystalline Diamond and Form a Hard Low-Wear Surface

Diamond films with an approximate thickness of 2 μm were deposited on nine SiC cylindrical seals. See U.S. Patent Publication No. 2005/0031785 to Carlisle et al. (application Ser. No. 10/892,736). The diamond coatings on these nine SiC seals were UNCD films deposited by reacting methane and hydrogen at elevated temperatures at pressures below atmosphere in a CVD process.

A pictorial view of the surfaces of the diamond films, illustrating the surface roughness and substantial asperities, is depicted in the representative 50×50 μm AFM 2D topographical map in FIG. 1. The average surface roughness values for resulting deposited films were measured using an Ambios XP1 2D contact line profilometer, and analyzed using TrueGage's TRUESURF® analysis software. The stylus end radius for the profilometer was about 2.50 μm. The diamond films had an Rₐ of approximately 20.5 nm as shown in FIG. 6 (“UNCD as deposited”). The average initial Rₐ of the SiC seal end-faces (“initial SiC surface”) as shown in FIG. 6, was about 7.6 nm. The outer diameter of the seals was about 2.000 inches (5.08 cm) and the inner diameter was about 1.375 inches (3.49 cm) with a total surface area of about 1.657 inch² (10.69 cm²) for the end subject to diamond film deposition.

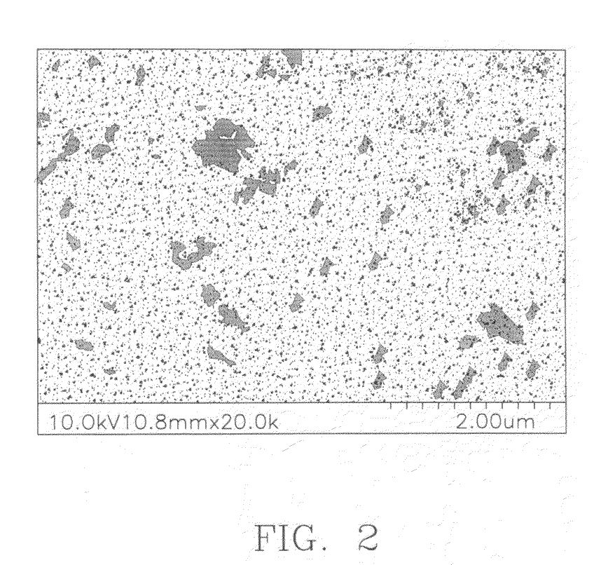

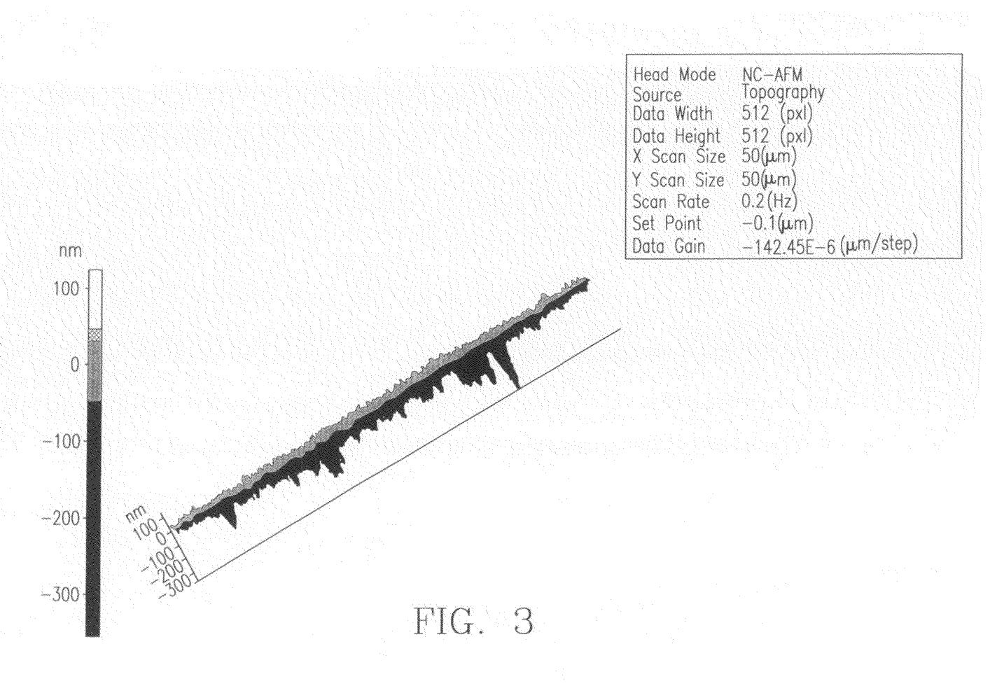

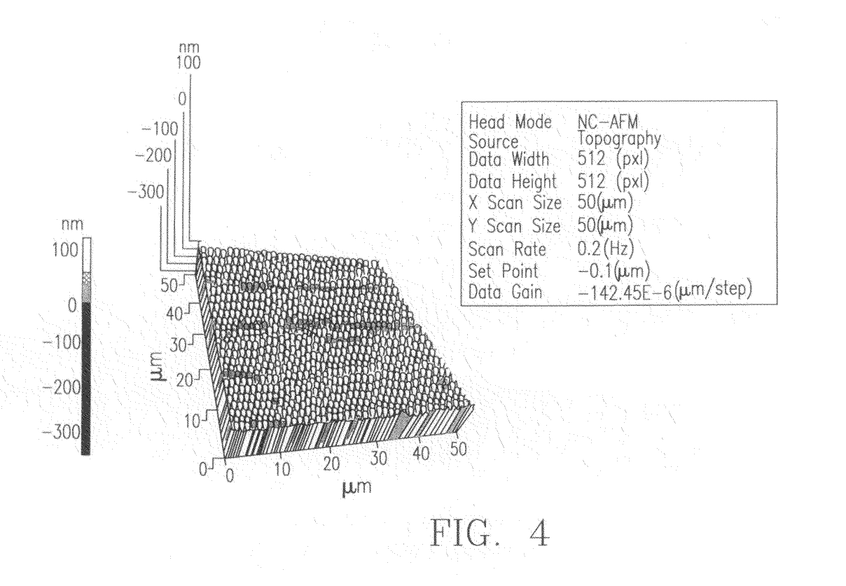

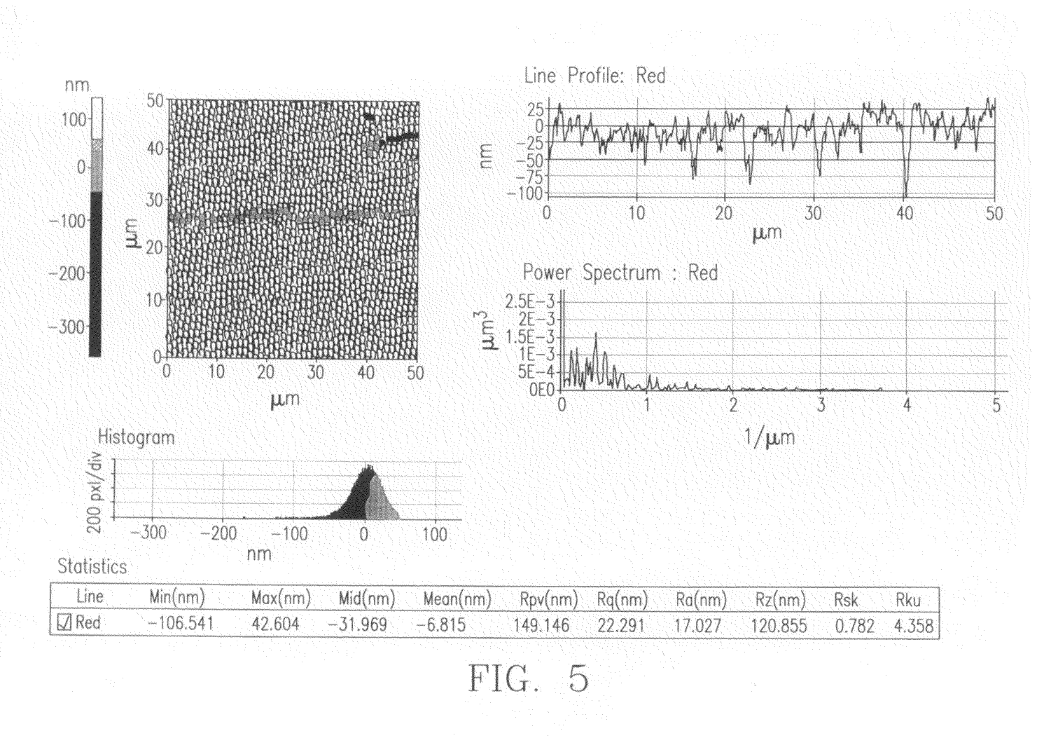

The diamond films were subsequently polished for about 90 seconds on an industry-standard planetary polishing system (LAPMASTER® 15 Diamond Lapping Polishing System) with a downforce of approximately 1 psi (6.89 kN/m²). A liquid polishing slurry comprising particulate diamond with an average particle size of about 6 μm was delivered to the film surface. The slurry had a pH of approximately 7. After polishing, the nine diamond end-face films deposited on the SiC seals exhibited an average “post-polish” Rₐ of about 8.8 nm as shown in FIG. 6. A SEM micrograph of the polished surface of a UNCD film is also shown in FIG. 2. The contrast between light and dark features in the SEM is attributable to the polycrystalline diamond grains with grain sizes on the order of about 10 to about 50 nm. AFM analysis of the planarized surface is shown in FIGS. 3-5. The analysis was conducted using an XE-HDD scanning probe by Park Systems (formerly PSIA) and XEI analysis software running in “contact mode” or “tapping mode.”

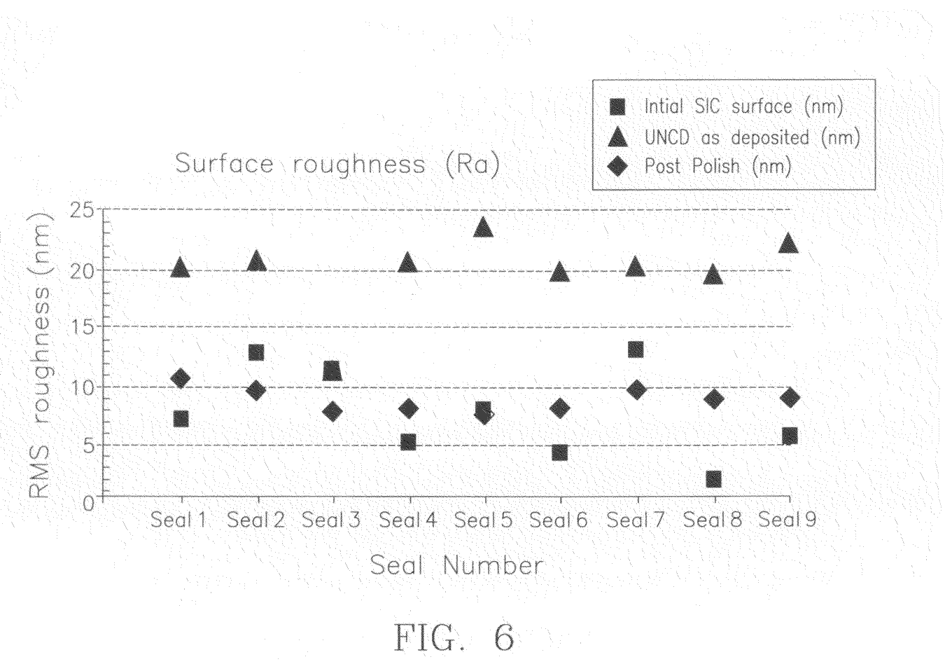

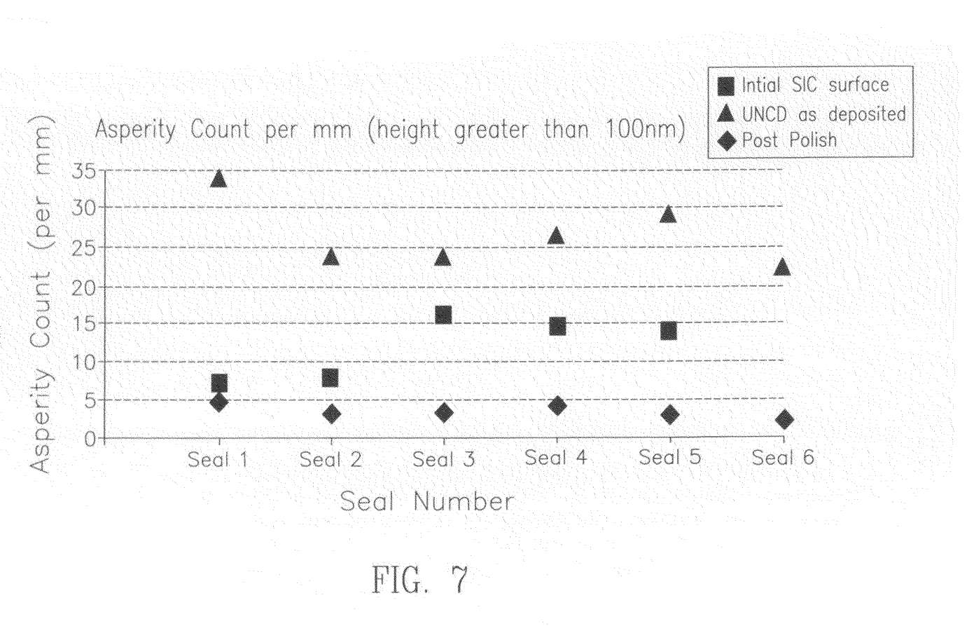

Analysis of the asperity count on the initial SiC surface, the UNCD film after deposition, and the post-polish surface were also conducted using the above-mentioned equipment and software. Asperities were operationally defined as regions of the surface of greater than 100 nm in height above the average surface. The asperity count data for six SiC seals are shown in FIG. 7. The asperity count in this figure results from counting of the number of localized peaks or asperities that have a height substantially above the Rₐ of the surface. The asperity counts depicted in FIG. 7 were obtained by noting the number of localized peaks within a profilometry scan made by a contacting with a diamond stylus having a tip diameter of 2 μm.

The average asperity count for asperities of 100 nm or greater height for the “initial SiC” surface was about 11.72 per linear millimeter (5860/mm²), and that for the “as deposited UNCD” film surface was about 26.52/mm (13260/mm²), and for the “post-polish” surface was about 3.17/mm (1585/mm²). The reduction in asperity count for the post-polish surface as compared to even the initial relatively smooth initial SiC surface is evidence for the unexpected effectiveness in producing tribological low wear surfaces using the methods of the present invention. The relatively short, 90 second, polishing of the diamond surfaces was sufficient to substantially remove the narrow positive asperities from the surface, while desirably leaving intact depressions extending below the average height of the surface. By comparison, the prior art methods of polishing diamond films have involved polishing the diamond surface for multiple hours.

Samples of these UNCD-coated seal faces also were tested for reduced wear, and their ability to reduce the wear of uncoated, often softer, counter faces. The wear testing included running Type 8-1 seals in hot-water at a temperature of about 250° F., a pressure of 100 psig, and flush flow of water at 20 gallons per minute (gpm) in an industrial pump. The polished seals were run against P685RC (carbon) primary faces for about 100 hours at 3,450 revolutions per minute (rpm). The observed wear of the carbon faces surprisingly was below about 0.00000 inches on the two seals that were run in the same test. For comparison, the observed wear of a carbon face that was tested in the same test run, under the same test conditions, but against a non-planarized, “as-prepared” UNCD-film, was about 0.00246 inches.

Samples of these UNCD-coated seals were also tested for their coefficient of sliding friction (CoF) against uncoated SiC seals (so-called “hard-on-hard” sliding friction) on an industry-standard friction tester. The friction test rig used for this analysis was a custom apparatus, which was calibrated against a similar rig located at John Crane, Inc. The friction rig evaluates the CoF of actual John Crane Type 8-1 seals with a shaft diameter of about 1.375 inches by dynamically measuring the face loading, torque, seal and liquid media temperature, and shaft rpm. Several CoF measurements were performed on these films, which exhibited a typical, and surprisingly low, CoF with SiC of about 0.018, as compared to a literature CoF for cleaved natural diamond of about 0.10 according to U.S. Pat. No. 5,898,511 (Gruen et. al.).

### Example. 2

Data were generated from diamond-coated seal faces that were polished for 6 minutes using methods similar to those of Example 1. The size of the polycrystalline grains in the diamond ranged up to and including grains of about 1 micron to about 2 microns, and the average grain size was estimated to be about 0.5 microns to about one micron.

(I) Coefficient of Friction Testing (CoF) on Seals: SiC Coated with Diamond-Coated and Uncoated SiC.

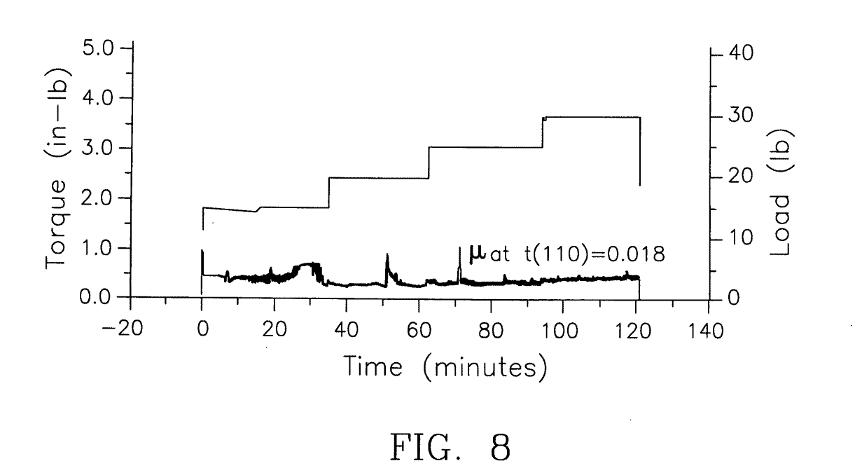

This testing was accomplished using an industry standard test methodology of measuring the applied load and the resulting torque generated at that load vs. time of a pair of contacting faces. One face was incorporated into a multi-spring seal head that was rotated at a constant speed against a stationary mating ring. The CoF of both uncoated SiC and diamond-coated SiC were evaluated running against SiC and carbon counter faces. The data is plotted with 2 y-axes (load and torque), vs. time on the x-axis (FIG. 8). The tests were conducted at 1800 rpm with applied load from 5 pounds to 30 pounds to press the seal against the pump head. The contacting area of the two faces was approximately 1.10 square inches. The results are also tabulated in Table 1.

TABLE 1

| Seal to Face Material | Measured | |
|---|---|---|
| Combination | COF | Comments |
| Uncoated SiC vs. uncoated | >0.435 | Measurement failed; COF |
| SiC | | too high* |
| Uncoated SiC vs. carbon | 0.161 | Comparison with prior art |
| | | seal material combination |
| Diamond-coated SiC vs. | 0.047 | Much lower |
| carbon | | |
| Diamond-coated SiC v. SiC | 0.018 | Much lower |

*SiC vs. SiC CoF has a literature value of 0.7 ± 0.15 for T < 250° C. and 0.4 ± 0.1 for T > 250° C.″ According to “NIST Structural Ceramics Database”, SRD Database Number 30 (“Material Properties of a Sintered alpha-SiC,” R. G. Munro, Journal of Physical and Chemical Reference Data, 26, 1195-1203 (1997)).

The CoF of 0.018 is a surprisingly low number and can translate into reduced face temperatures in actual use. An example of a dramatic impact of low CoF values can be seen in an increase in the seal's ability to “run dry.” During normal seal operation, the pumping media and “seal flush” are responsible to moving the frictional heat away from the seal faces. However, “running dry” is one of the common conditions that occurs during actual seal use or start-up that detrimentally impacts the seal's useful life. During dry operation, the heat generated by the friction between the faces can quickly result in either the faces actually cracking or the seal's secondary sealing elements failing. Both cases can result in catastrophic seal failure. Currently, a “standard” material of choice when requiring low friction and resistance to dry running is SiC vs. carbon. The diamond-coated vs. SiC seal combination results in a substantially more abrasive resistant seal (elimination of soft carbon), higher strength (due to the replacement of the carbon by SiC), and lower temperature operation when run dry (CoF of <0.02).

CoF testing was also conducted in substantially parallel tests except polishing was not carried out. These tests showed carbon-faced wear resulting in failure.

(II) Seal Wear Tests Demonstrating the Effect of Diamond Coating on Wear Using an Accelerated Wear Test that Based on the Lack of a Lubricating Film when Pumping Water at High Temperatures.

Two material combinations (diamond-coated SiC vs. carbon and SiC vs. carbon) were evaluated using an aggressive wear test that is designed to accelerate wear and test the durability of seal materials under harsh conditions. The amount of wear was then evaluated using a radial profilometry test and photographs to measure the depth of the grooving caused by the wear test.

A Goulds 3196 pump (a standard 1⅜″ ANSI pump) was operated to pump water at 250° F. in a closed loop at 150 psig at 3650 rpm (˜3000 feet per minute rotational velocity). Due to the low viscosity of the water at the pumping conditions the seal faces actually come into contact. The nature of the contact during this test is cyclic and results from a flashing of the water at the faces, contact, followed by face separation resulting from the introduction of new flush water. This high temperature water condition is a recognized industry standard for creating a very poor lubricating condition between the seal faces. The tests were conducted for 100 hours both sets of seal materials (diamond-coated SiC vs. carbon and SiC vs. carbon). The diamond coating had been polished for about 6 minutes according the methods described in Example 1.

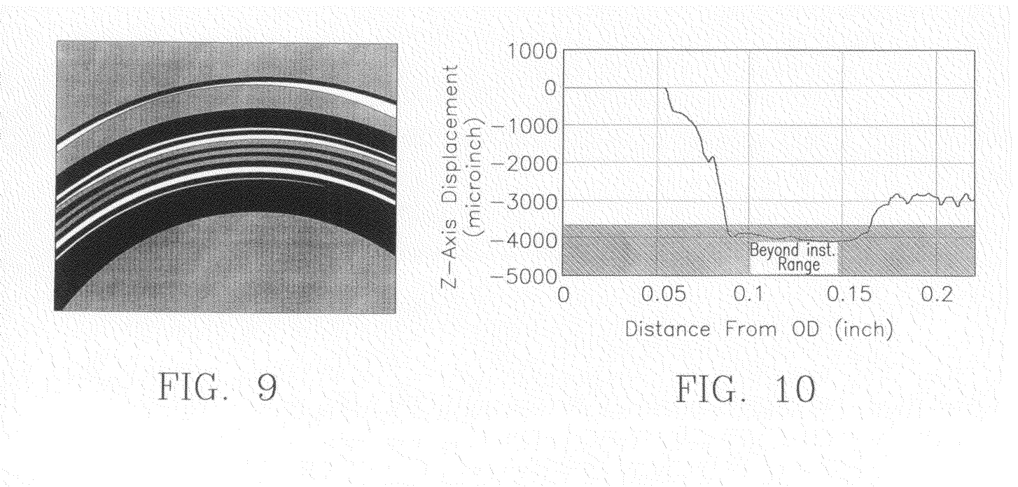

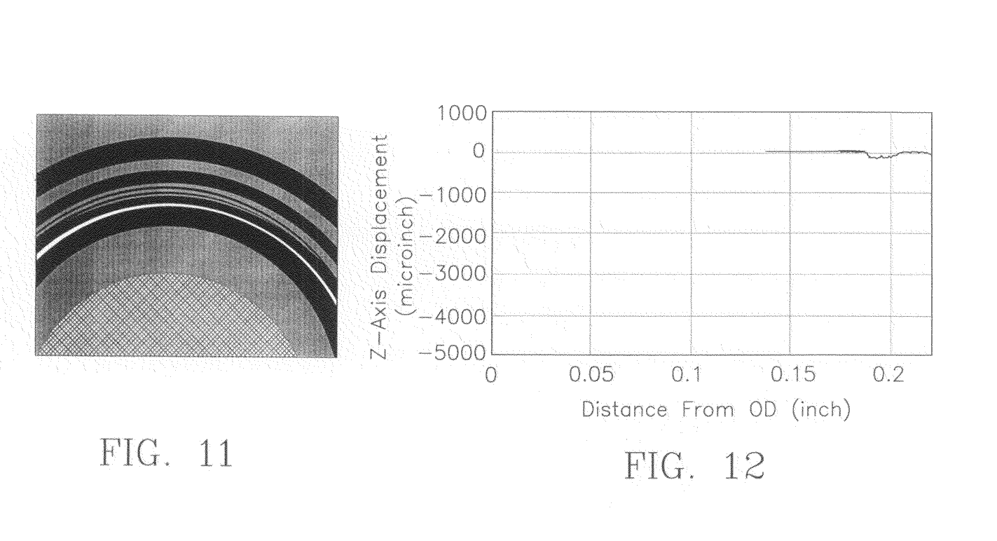

The radial profilometry tests and photographs in FIGS. 9-12 show that the SiC-carbon demonstrated severe wear after the 100 hour test. The SiC seal material showed (FIGS. 9, 10) wear groove depths above 4000 micro-inches, i.e. 100 μm (radial profilometry instrument was beyond its measurement range). The diamond-coated seal showed (FIGS. 11, 12) almost no wear, i.e. about 50 micro-inches, i.e. about 1.3 μm (or less).

The seal contact area was again about 1.10 square inches during the test. The inside diameter of the stationary mating rings, depicted in the photographs in FIGS. 9 and 11, were approximately 1.417 inches and the outer diameter (OD) was 1.982 inches. The nominal radial trace length of the profilometry results were 7.5 mm (0.3 inches).

Implications of these results for “lubricant failure” include that diamond-coated seals provide a dramatic improvement in the wear performance of the interface even under extreme conditions. This would provide a safety margin for use of such seals in extreme environments. Diamond is also a much less chemically active surface and therefore can be used in environments which would cause corrosion or failure for other materials.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of preparing a planarized diamond film comprising:
removing diamond asperities from the surface of a polycrystalline diamond film disposed on a substrate; the diamond film including diamond asperities on said surface, and depressions in said surface, and having an average surface height above the substrate, an initial average film thickness, and an initial average surface roughness;
wherein the diamond asperities have a height/width ratio of greater than about 1:1, and a height above the average surface height of the film of greater than about three times the initial average surface roughness of the film; and the depressions in the surface extend more than about 25 nm below the average surface height of the film, and wherein the film has a final average film thickness, after removing asperities, which is not more than 500 nm thinner than the initial average film thickness of the film.

2. The method according to claim 1, wherein the film has an average surface roughness of about 50 nm or less after removing asperities from the surface.

3. The method according to claim 1, wherein the film has an average surface roughness of about 20 nm or less after removing asperities from the surface.

4. The method according to claim 1, wherein the film has an average grain size selected from the group consisting of (a) about 2000 nm or less, (b) about 1000 nm or less, (c) about 100 nm or less, (d) about 50 nm or less, (e) about 20 nm or less, and (f) about 10 nm or less.

5. The method according to claim 1, wherein the film has a coefficient of sliding friction with SiC of less than about 0.0 after removing asperities from the surface.

6. The method according to claim 1, wherein the film has fewer than about 2000 diamond asperities per square millimeter after removing asperities from the surface.

7. The method according to claim 1, wherein the diamond asperities have a height above the average surface height of the film of greater than about ten times the initial average surface roughness prior to removing asperities from the surface.

8. The method according to claim 1, wherein the depressions in the surface of the film comprise about 1% to about 30% of the area of the surface, and the final average film thickness of the film is selected to preserve the depressions in the surface.

9. The method according to claim 1, wherein the step of removing asperities comprises polishing the surface with an abrasive material.

10. The method according to claim 1, wherein the step of removing asperities comprises polishing the surface with an abrasive material for about 10 minutes or less.

11. The method according to claim 1, wherein the step of removing asperities comprises polishing the surface with a slurry of abrasive particles.

12. The method according to claim 11, wherein the slurry of abrasive particles comprises diamond, silicon carbide, zirconia, or alumina particles.

13. The method according to claim 11, wherein the step of removing asperities comprises polishing the surface with a slurry of abrasive particles at a down force of about 3 psi or less.

14. The method according to claim 1, wherein the diamond film has an asperity surface density of at least about 10000 per square millimeter before removing asperities from the surface.

15. The method according to claim 1, wherein the substrate comprises silicon carbide.

16. The method according to claim 1, wherein the final average film thickness is a thickness selected from the group consisting of (a) not more than about 100 nm thinner than the first diamond film thickness, (b) not more than about 50 nm thinner than the first diamond film thickness, (c) not more than about 25 nm thinner than the first diamond film thickness, and (d) not more than about 10 nm thinner than the first diamond film thickness.

17. The method according to claim 1, wherein the final average film thickness is about equal to the initial average film thickness.

18. A method of preparing a planarized diamond film comprising:
removing a layer of diamond having a thickness of not more than about 500 nm, on average, from the surface of a polycrystalline diamond film disposed on a substrate; wherein the diamond film has an average surface roughness after removing the layer of diamond, which is less than the average surface roughness of the film before removing the layer of diamond.

19. The method according to claim 18, wherein the surface of the diamond film includes diamond asperities having a height/width ratio of greater than about 1:1, and a height above the average surface height of the film of greater than about three times the initial average surface roughness of the film; the number of asperities per unit area present on the surface after removing the layer of diamond being less than the number of asperities per unit area present on the surface before removing the layer of diamond

20. The method according to claim 18, wherein about 1% to about 30% of the surface area of the film comprises depressions having a depth of greater than about 25 nm below the average surface height of the film, and wherein the depressions are preserved during the step of removing the layer of diamond.

21. The method according to claim 18, wherein the average grain size is selected from the group consisting of (a) about 2000 nm or less, (b) about 1000 nm or less, (c) about 100 nm or less, (d) about 50 nm or less, (e) about 20 nm or less, and (f) about 10 nm or less.

22. The method according to claim 18, wherein the step of removing the layer of diamond comprises polishing the surface with an abrasive material.

23. The method according to claim 18, wherein the average surface roughness after removing the layer of diamond is not more than about 50 nm.

24. An article of manufacture prepared according to the method of claim 1.

25. An article of manufacture prepared according to the method of claim 18.

26. An article comprising:
a substrate having disposed thereon a polycrystalline diamond film, about 1% to about 30% of the surface of the film being depressed by about 25 nm or more compared to the average height of the surface; wherein the film has an average surface roughness of about 50 nm or less, and includes fewer than about 2000 asperities per square millimeter, wherein the asperities have a height/width ratio of greater than about 1:1 and a height above the average height of surface of the film of greater than about three times the average surface roughness of the film.

27. The article according to claim 26, wherein the diamond has an average grain size selected from the group consisting of (a) about 2000 nm or less, (b) about 1000 nm or less, (c) about 100 nm or less, (d) about 50 nm or less, (e) about 20 nm or less, and (f) about 10 nm or less.

28. The article according to claim 26, wherein the diamond has a coefficient of sliding friction with SiC of less than about 0.1.
